(19) United States
(12) Patent Application Publication
(10) Pub. No.: US 2009/0101757 A1
(43) Pub. Date: Apr. 23, 2009

(54) Architecture and method of constructing a Geosynchronous Earth Orbit platform using solar electric propulsion

(75) Inventor: Henry W. Brandhorst, JR., Auburn, AL (US)

Correspondence Address: HAVERSTOCK & OWENS LLP, 162 N WOLFE ROAD, SUNNYVALE, CA, 94086, US

(73) Assignee: AUBURN UNIVERSITY, an Alabama Corporation

(21) Appl. No.: 12/148,698

(22) Filed: Apr. 21, 2008

Related U.S. Application Data
(60) Provisional application No. 60/999,642, filed on Oct. 19, 2007.

(51) Int. Cl. B64G 1/40

(52) U.S. Cl. 244/172.4; 244/171.3

(57) ABSTRACT

A space construction method and system transports construction materials, a propellant depot, solar electric propulsion (SEP) vehicles, and robotic equipment from Earth into a lower-Earth orbit. The SEP vehicles are used to transport payload between the lower-Earth orbit and a construction area in higher-Earth orbit, such as GEO. The robotic equipment transfers materials between various vehicles and assembles the transported construction materials in the higher-Earth orbit. A tug SEP vehicle transports heavier construction materials from the propellant depot in lower-Earth orbit to the construction area in higher-Earth orbit. A propulsion stage SEP vehicles transport lighter construction materials from the propellant depot to the construction area. The tug is also transports the fuel-depleted propulsion stages from higher-Earth orbit back to the propellant depot in lower-Earth orbit, where both the tug and the propellant stages are refueled and reloaded for another trip to the construction area in higher-Earth orbit. As additional supplies they are transported from Earth to the propellant depot in lower-Earth orbit.

### RELATED APPLICATION(S)

This application claims priority under 35 U.S.C. § 119(e) of the co-pending, co-owned U.S. Provisional Patent Application, Ser. No. 60/999,642, filed Oct. 19, 2007, and entitled “ARCHITECTURE AND METHOD OF CONSTRUCTING A GEOSYNCHRONOUS EARTH ORBIT PLATFORM USING SOLAR ELECTRIC PROPULSION.” The Provisional Patent Application, Ser. No. 60/999,642, filed Oct. 19, 2007, and entitled “ARCHITECTURE AND METHOD OF CONSTRUCTING A GEOSYNCHRONOUS EARTH ORBIT PLATFORM USING SOLAR ELECTRIC PROPULSION” is also hereby incorporated by reference in its entirety.

### FIELD OF THE INVENTION

The present invention relates to the field of space transportation and construction. More particularly, the present invention relates to a system and method of constructing a geosynchronous earth orbit platform using reusable vehicles powered by solar electric propulsion.

### BACKGROUND OF THE INVENTION

A current limiting factor in constructing space-based structures is the cost associated with transporting the requisite structures, either as a whole or in pieces, and construction equipment to the site of construction in orbit. For construction of structures in higher-Earth orbits, such as a Geosynchronous Earth Orbit (GEO), transportation costs are especially high. Launch vehicles are used to carry payload, including construction supplies and equipment, directly from Earth to the construction site. These launch vehicles, such as the space shuttle and the propulsion system used to launch the space shuttle into orbit, typically use chemical-based propulsion systems, which are inefficient and use expensive fuel. Other types of launch vehicles, such as magnetic levitation devices, gun launches, which use magnetic levitation or electromagnetic means, space elevators, or hybrid tether systems or skycranes, are unproven.

At present, the ability to move large amounts of mass into Earth orbit, especially higher-Earth orbits, and the capabilities for in-space construction are limited.

### SUMMARY OF THE INVENTION

A space construction method and system transports construction materials, a propellant depot, solar electric propulsion (SEP) vehicles, and robotic equipment from Earth into a lower-Earth orbit. The SEP vehicles are used to transport payload between the lower-Earth orbit and a construction area in higher-Earth orbit, such as GEO. The robotic equipment transfers materials between various vehicles and assembles the transported construction materials in the higher-Earth orbit. The tug SEP vehicle transports heavier construction materials from the propellant depot in lower-Earth orbit to the construction area in higher-Earth orbit. The propulsion stage SEP vehicles transport lighter construction materials from the propellant depot to the construction area. The tug is also configured to transport the fuel-depleted propulsion stages from higher-Earth orbit back to the propellant depot in lower-Earth orbit, where both the tug and the propellant stages are refueled and reloaded for another trip to the construction area in higher-Earth orbit. As additional supplies are needed, such as fuel to refill the propellant depot, base structure components, and solar arrays, these supplies are transported from Earth to the propellant depot in lower-Earth orbit. In this manner, the propellant depot, the tug, and the propellant stages are reusable, thereby enabling many transportation cycles between the staging area in lower-Earth orbit and the construction area in higher-Earth orbit.

In one aspect, a system for constructing a structure in space is disclosed. The system includes a propellant depot configured to store fuel, wherein the propellant depot is positioned in a lower-Earth orbit, one or more propulsion stages each configured to transport cargo from the lower-Earth orbit to a higher-Earth orbit, a tug configured to transport hardware between the propellant depot in lower-Earth orbit and the higher-Earth orbit, and to transport one or more propulsion stages less cargo from the higher-Earth orbit to the propellant depot in lower-Earth orbit, and a launch vehicle configured to transport the propellant depot, the tug, the hardware, the one or more propulsion stages, and the cargo from Earth to the lower-Earth orbit. Each propulsion stage can be configured to receive fuel from the propellant depot. The cargo can be a plurality of solar arrays. The one or more solar arrays can be configured to be mounted to the propulsion stage while in the lower-Earth orbit and to be removed from the propulsion stage once in higher-Earth orbit, and each propulsion stage includes solar electric propulsion and is configured to receive solar-based energy from the mounted one or more solar arrays. The tug is configured to receive fuel from the propellant depot. The hardware can be a plurality of base structure components. The tug can include solar electric propulsion.

In another aspect, a method of constructing a structure in space is disclosed. The method includes transporting a propellant depot, a tug, hardware, cargo, and one or more propulsion stages from Earth to a lower-Earth orbit. The method also includes loading the tug with the hardware, transporting the tug including the hardware to a higher-Earth orbit, and removing the hardware from the tug. The method further includes loading each of the one or more propulsion stages with cargo, transporting the one or more propulsion stages to the higher-Earth orbit, and removing the cargo from each of the one or more propulsion stages. The method still further includes coupling one or more of the one or more propulsion stages to the tug and transporting each of the propulsion stages from the higher-Earth orbit to the propellant stage in the lower-Earth orbit.

The higher-Earth orbit is further from Earth than the lower-Earth orbit. The one or more propulsion stages are transported to the hardware in the higher-Earth orbit. The hardware can be a plurality of base structure components. The cargo can be a plurality of solar arrays. The method can also include mounting one or more solar arrays to each of the propulsion stages. The method can also include removing the one or more solar arrays mounted to each propulsion stage, and mounting the one or more solar arrays removed from each propulsion stage to the hardware in the higher-Earth orbit. The tug and each of the one or more propulsion stages can include solar electric propulsion. Each propulsion stage can receive solar-based energy from the one or more solar arrays while the one or more solar arrays are mounted to the propulsion stage. In some embodiments, the steps of transporting the propellant depot, the tug, the hardware, the cargo, and the one or more propulsion stages, loading the tug with the hardware, transporting the tug to the higher-Earth orbit, removing the hardware from the tug, loading each of the one or more propulsion stages with cargo, transporting the one or more propulsion stages to the higher-Earth orbit, removing the cargo from each of the one or more propulsion stages, coupling one or more of the one or more propulsion stages to the tug, and transporting each of the propulsion stages are performed robotically such that the method of constructing is fully automated. In some embodiments, the method also includes the steps of fueling the tug from the propellant depot and fueling each of the one or more propulsion stages from the propellant depot.

In some embodiments, the method also includes reloading the tug with additional hardware, transporting the tug including the additional hardware to the higher-Earth orbit, and removing the additional hardware from the tug. In some embodiments, the method includes mounting the additional hardware to the previously transported hardware, loading additional cargo into each of the propulsion stages, and transporting the one or more propulsion stages including the additional cargo to the hardware in the higher-Earth orbit. In some embodiments, the method further includes removing the additional cargo from each propulsion stage, mounting the additional cargo removed from each propulsion stage to the hardware or the additional hardware, coupling each of the propulsion stages less the additional cargo to the tug, and transporting each of the propulsion stages from the higher-Earth orbit to the propellant stage in lower-Earth orbit. In some embodiments, the method also includes refueling the tug from the propellant depot and refueling each of the plurality of propulsion stages from the propellant depot.

The method also includes repeating the additional steps until the structure in higher-Earth orbit is completed. In some embodiments, the method also includes periodically transporting additional supplies from Earth to lower-Earth orbit, wherein the additional supplies include additional fuel for the propellant depot, additional base structure components, and additional solar arrays. The lower-Earth orbit can be at altitude of about 300 km to about 500 km. The higher-Earth orbit can be at a Geosynchronous Earth Orbit. The propellant depot includes one or more fuel storage tanks, fuel stored in the fuel storage tanks, transfer equipment configured to transfer materials from a launch vehicle to the tug and to each of the propulsion stages, and a power system. The fuel can be one of the group consisting of argon, xenon, ammonia, water, hydrogen or other fuels used in electric propulsion systems. In some embodiments, the tug includes about 300 kW to more than 1000 kW of electric power. The tug can be configured to transport up to about 10,000 kg. Each propulsion stage can be configured to transport up to about 1500 kg. In some embodiments, the tug and each propulsion stage includes one or more fuel tanks, an electric propulsion thruster system, an attitude control system, a power management system, memory, a power processing system, and a guidance, navigation, and control system. Each propulsion stage can include about 100 kW to about 500 kW or more of electric power. Each of the steps are able to be performed robotically such that the method of constructing is fully automated. The method also includes utilizing a plurality of tugs. In some embodiments, the structure is a space-based solar power platform. Each propulsion stage receives solar-based energy from the one or more solar arrays while the one or more solar arrays are mounted to the propulsion stage.

In another aspect, a system for constructing a structure in space is disclosed. The system includes a propellant depot, one or more propulsion stages, a tug, and a launch vehicle. The propellant depot is configured to store fuel, and the propellant depot is positioned in a lower-Earth orbit. The one or more propulsion stages are each configured to receive fuel from the propellant depot and to transport one or more solar arrays from the lower-Earth orbit to a higher-Earth orbit, wherein the one or more solar arrays are configured to be mounted to the propulsion stage while in the lower-Earth orbit and to be removed from the propulsion stage once in higher-Earth orbit, and each propulsion stage includes solar electric propulsion and is configured to receive solar-based energy from the mounted one or more solar arrays. The tug is configured to receive fuel from the propellant depot, to transport one or more base structure components between the propellant depot in lower-Earth orbit and the higher-Earth orbit, and to transport one or more propulsion stages less solar arrays from the higher-Earth orbit to the propellant depot in lower-Earth orbit, wherein the tug includes solar electric propulsion. The low-cost launch vehicles are configured to transport the propellant depot, the tug, the base structure components, the one or more propulsion stages, and the solar arrays from Earth to the lower-Earth orbit. The structure in space is constructed from the base structure components and the solar arrays. Each base structure component is coupled to at least one other base structure component in higher-Earth orbit, and each solar array is coupled to at least one base structure component in higher-Earth orbit.

In some embodiments, the system also includes one or more robotic devices configured to load and unload the one or more base structure components on and off the tug, to mount and remove the one or more solar arrays on and off each propulsion stage, and to construct the structure in higher-Earth orbit using the base structure components and the solar arrays. The propellant depot, the one or more propulsion stages, and the tug are able to be automated. The system can also include a plurality of tugs. The system can also include a plurality of launch vehicles. The propellant depot, the plurality of propulsion stages, the tug, and the launch vehicle are able to be reusable. The launch vehicle is able to be configured to transport additional supplies from Earth to lower-Earth orbit, wherein the additional supplies include additional fuel for the propellant depot, additional base structure components, and additional solar arrays. The tug and the plurality of propulsion stages are configured to be refueled.

### BRIEF DESCRIPTION OF THE DRAWINGS

FIG. 1 illustrates an exemplary method of constructing a space platform in accordance with one embodiment of the present invention.

FIGS. 2-7 illustrate an exemplary system architecture in various stages of constructing the space platform in GEO.

Embodiments of the space platform construction method are described relative to the several views of the drawings. Where appropriate and only where identical elements are disclosed and shown in more than one drawing, the same reference numeral will be used to represent such identical elements.

### DETAILED DESCRIPTION OF THE EMBODIMENTS

Embodiments of the present invention are directed to an improved method of constructing space platforms. Those of ordinary skill in the art will realize that the following detailed description of the present invention is illustrative only and is not intended to be in any way limiting. Other embodiments of the present invention will readily suggest themselves to such skilled persons having the benefit of this disclosure.

Reference will now be made in detail to implementations of the present invention as illustrated in the accompanying drawings. The same reference indicators will be used throughout the drawings and the following detailed description to refer to the same or like parts. In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

A significant issue to constructing a space platform in a higher-Earth orbit, such as Geosynchronous Earth Orbit (GEO) is the transportation costs of delivering the completed platform, or components thereof. The space construction method and corresponding system for implementing the method significantly reduces such transportation costs. In one exemplary application, the cost of transporting material to GEO using the space construction method of the present invention provides a cost savings factor of approximately 10-15 over conventional methods. Instead of transporting the construction materials directly to the construction area in GEO, the space construction method first transports the materials to LEO using the current class of low cost launch vehicles, and then using reusable solar electric propulsion (SEP) vehicles to transport the materials from LEO to GEO. In some embodiments, LEO refers to a lower-Earth orbit with an altitude of about 300 km to about 500 km above the Earth's surface. In other embodiments, LEO refers to any lower-Earth orbit that is closer to the Earth's surface than GEO.

Embodiments of the present invention are directed to an architecture and method of constructing a large, multi-component GEO space platform using solar electric propulsion (SEP) and reusable transportation architecture. Each SEP vehicle includes two sources of power, solar arrays and a fuel-based electric propulsion thruster system. Examples of such electric propulsion thruster systems include, but are not limited to, a Hall thruster, an ion thruster, a pulsed induction thruster (PIT), a Farad, and a VASIMR. The space platform construction method includes the use of two different types of SEP vehicles. A first SEP vehicle is referred to as a propulsion stage, and a second SEP vehicle is referred to as a tug. The propulsion stage and the tug each include one or more propellant tanks, an electric propulsion thruster system, an attitude control system, a power management system, memory, a power processing system, and a guidance, navigation, and control (GN&C) system. The tug is designed to transport heavier payloads, such as space platform base structure components, and the propulsion stage is designed to transport lighter payloads that are to be coupled to the larger components of the space platform. In an exemplary application, the tug is configured to transport up to about 10,000 kg, and each propulsion stage is configured to transport up to about 1500 kg.

In one exemplary embodiment, the base structure is comprised of a truss structure, components of which are transported piecemeal from LEO to GEO by the tug. In this exemplary embodiment, the propellant stage transports solar arrays from LEO to GEO, where each solar array is robotically attached to the truss structure components transported by the tug. The tug and the propulsion stage are reusable in the sense that each is refuelable and are used for multiple different transport runs, as will be described in greater detail to follow.

Embodiments to follow are directed to a system and method of constructing a space-based solar power (SBSP) platform including a base structure and solar array. It is understood that the SBSP platform is but one example of a space platform that can be constructing using the space platform construction method described herein.

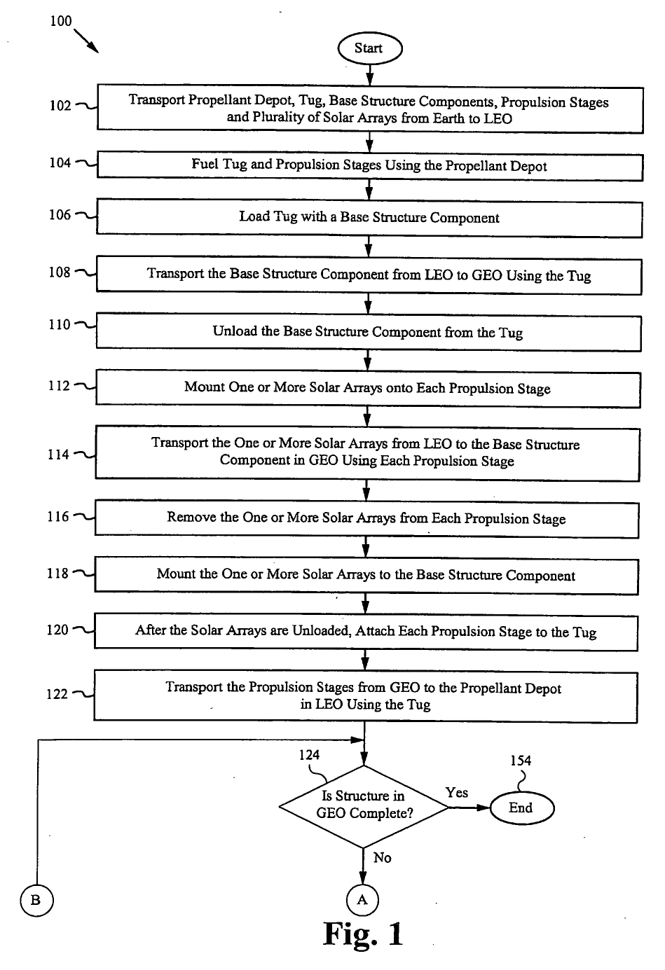

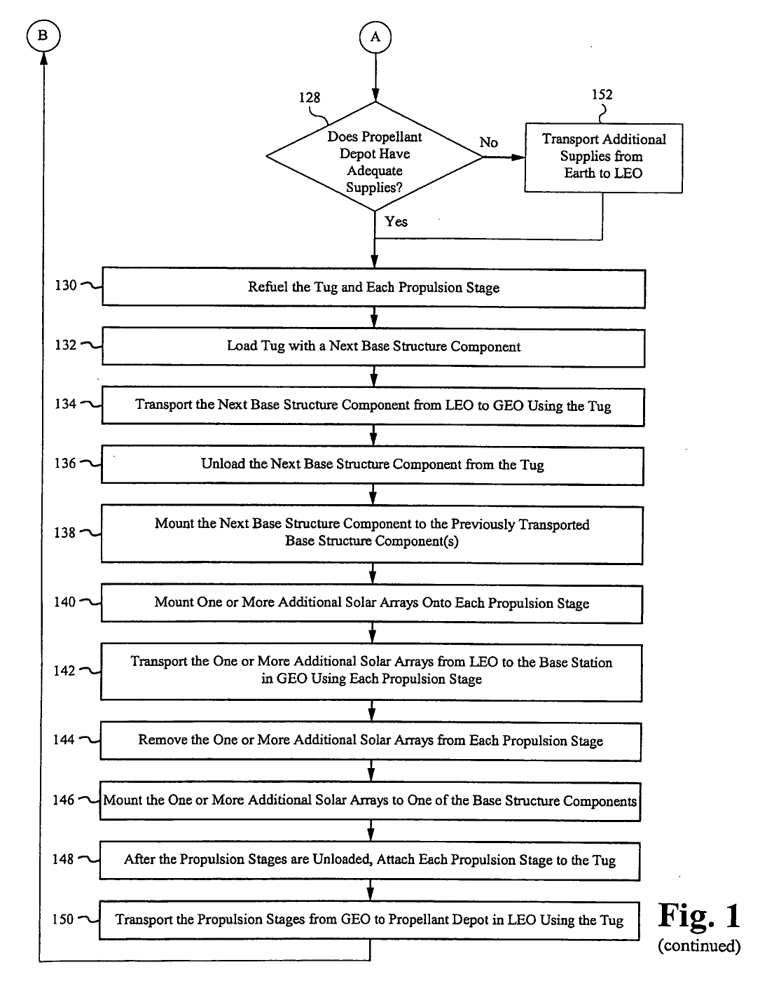

FIG. 1 illustrates an exemplary method of constructing a space platform in accordance with one embodiment of the present invention. In this exemplary case, the space platform is a SBSP platform including a base structure and plurality of solar arrays coupled to the base structure. The base structure is constructed from a plurality of base structure components coupled together. In some embodiments, the base structure is a truss structure. The space platform construction method 100 begins at the step 102 by transporting a propellant depot, a tug, a plurality of base structure components, a plurality of propulsion stages, and a plurality of solar arrays from Earth to LEO. Transportation is accomplished using any appropriate launch vehicle. In some embodiments, the transportation step 102 is a single step. In other embodiments, the transportation step 102 is a series of multiple different transportation steps. For example, a first transportation step transports the propellant depot from Earth to LEO, a second transportation step transports the tug, the plurality of base structure components, and the plurality of propulsion stages from Earth to LEO, and a third transportation step transports the plurality of solar arrays from the Earth to LEO. It is contemplated that more or less than three transportation steps can be performed, and that each transportation step can transport a different combination of materials than the three transportation steps described above.

In some embodiments, a large number of solar arrays are packaged into a single launch from Earth to LEO. In this manner, megawatts of power are loaded into a single launch to LEO. In one exemplary application, the solar array has a packing density of about 80 kW/m³ and a specific power of at least 300 W/kg. In some embodiments, the solar arrays are Stretched Lens Arrays on Square Rigger (SLASR) platform. Alternatively, any conventional type of solar arrays are able to be used.

The propellant depot includes fuel storage tanks, propellant stored in the fuel storage tanks, transfer equipment configured to transfer materials from a launch vehicle to one of the tugs or one of the propulsion stages, and a power system to operate each of the components of the propellant depot. The propellent depot is configured to be refueled once depleted. The fuel used for refueling is transported from Earth to LEO in a manner similar to the transportation step 102. The fuel stored in the propellant depot is used to fuel the tug and each of the propulsion stages. The fuel is argon, xenon, ammonia, water, hydrogen or any other fuel that can be used with the electric propulsion thruster. An advantage of using fuel designated for electric propulsion thrusters is that unlike other fuels, such as cryogenic hydrogen, the electric propulsion fuel does not need to be stored at a low temperature. Another advantage of the electric propulsion fuel is that it is easy to store and is relatively inexpensive when compared to other types of fuel such as liquid hydrogen and liquid oxygen.

At the step 104, the tug and each of the propulsion stages are fueled using fuel stored in the propellant depot. At the step 106, the tug is loaded with a base structure component. In some embodiments, the tug is loaded with multiple base structure components. The number of base structure components that the tug is loaded with is application dependent, based primarily on the size and weight of each component and the payload capacity of the tug. The tug and each of the propellant stages are configured as SEP vehicles, and as such are powered by both solar arrays and fuel-based electric propulsion thruster systems. In some embodiments, the tug and each propellant stage are transported from Earth to LEO without solar arrays being mounted. In this case, solar arrays are mounted onto the tug to collect solar energy and subsequently generate electric power. In some embodiments, the tug generates about 300 kW to more than 1000 kW of electric power from the mounted solar arrays. Once loaded, at the step 108, the tug transports the loaded base structure component(s) from the propellant depot in LEO to GEO. At the step 110, the base structure component(s) is unloaded from the tug, thereby forming the basis of a space platform base structure in GEO.

At the step 112, each propulsion stage is mounted with one or more solar arrays. The number of solar arrays that each propulsion stage is mounted with is application dependent, based primarily on the payload capacity of the propulsion stage and the corresponding electrical power requirements. In some embodiments, each propulsion stage generates about 100 kW to about 500 kW of electric power from the mounted solar arrays. Once loaded, at the step 114, each propulsion stage transports the solar array(s) from the propellant depot in LEO to the base structure component(s) transported to GEO in the step 108. In some embodiments, transportation of each propulsion stage from LEO to GEO is staggered. That is, a first propulsion stage makes the trip from LEO to GEO, followed by a second propulsion stage, and so on. The time delay between each trip can be synchronized to a periodic schedule, or can be random according to when each propulsion stage is fueled and loaded. The time delay can also be scheduled such that multiple different propulsion stages are concurrently in transport, yet staggered in time and distance along the path between LEO and GEO. In some embodiments, all of the propulsion stages make the trip from LEO to GEO at the same time, so as to all leave the propellant depot at the same time and all arrive at the base structure at approximately the same time. It is understood that any transportation schedule can be used to schedule the individual transportation of each propulsion stage from LEO to GEO.

As each propulsion stage arrives at the base structure component(s) in GEO, the solar array(s) mounted onto the propulsion stage is removed at the step 116. At the step 118, the solar array(s) removed at the step 116 is mounted to the base structure component transported at the step 108. Each solar array is removed from the propulsion stage and mounted to the base structure component using robotic devices. Such robotic devices are integrated as either part of the base structure component or the propulsion stage. Alternatively, a robotic device independent of the other components is used to remove and mount the solar arrays. Such a robotic device is transported to GEO using either the tug or one of the propulsion stages. After the solar array(s) is removed, the propulsion stage less solar array(s) is coupled to the tug as cargo at the step 120, for transport back to the propellant depot in LEO. The tug is configured to transport one or more propulsion stages from GEO to LEO. In some embodiments, the tug does not start the trip until it is fully loaded with a designated number of propulsion stages. In other embodiments, the tug makes the trip from GEO to LEO without being fully loaded. At the step 122, the tug transports the propulsion stages from the base structure component in GEO to the propellant depot in LEO.

At the step 124, it is determined if the present state of the space platform is complete. If it is determined at the step 124 that the space platform is complete, then the method ends at the step 154. If it is determined at the step 124 that the space platform is not completed, then at the step 128 it is determined if sufficient supplies are present at the propellant depot in order to complete another cycle of construction. Supplies refers to fuel, base structure components, solar arrays, or other construction material or equipment used in the construction of the space platform. The propellant depot is configured with refillable fuel storage tanks so that the propellant depot is refueled with additional fuel transported from Earth. If it is determined at the step 128 that additional supplies are needed, then at the step 154 additional supplies are transported from Earth to the propellant depot in LEO. The additional supplies are transported in a manner similar to that of the transportation step 102. It is understood that the step 124 and 128 can be performed on an ongoing basis, such that as it is determined that additional supplies are needed, the additional supplies are transported to the propellant depot and are ready for use upon the return of the tug and propulsion stage(s) from GEO.

After the tug and the propulsion stages return to the propellant depot, the tug and the propulsion stages are refueled at the step 130. At the step 132, the tug is loaded with another base structure component. In some embodiments, the tug is loaded with multiple base structure components. At the step 134, the tug transports the newest load of base structure component(s) from the propellant depot in LEO to GEO. At the step 136, the base structure component(s) is unloaded from the tug. At the step 138, the base structure component unloaded at the step 136 is mounted to the base structure component(s) previously transported at the step 108, thereby extending the base structure of the space platform.

At the step 140, each propulsion stage is mounted with one or more solar arrays. At the step 142, each propulsion stage transports the newest supply of solar array(s) from the propellant depot in LEO to the base structure in GEO. Transportation of each propulsion stage can be staggered in a manner similar to that at the step 114, or according to a different transportation schedule.

As each propulsion stage arrives at the base structure in GEO, the solar array(s) mounted onto the propulsion stage is removed at the step 144. At the step 146, the solar array(s) removed at the step 144 is mounted to the base structure component transported at the step 134. Alternatively, the solar array(s) removed at the step 144 is mounted to any of the base structure components currently comprising the base structure in GEO. After the solar array(s) is removed, the propulsion stage less solar array(s) is coupled to the tug as cargo at the step 148, for transport back to the propellant depot in LEO. At the step 150, the tug transports the propulsion stages less solar array(s) from the base structure component in GEO to the propellant depot in LEO. The process repeats at the step 124 until the space platform is completed.

The order of the construction steps shown in FIG. 1 are for exemplary purposes only. It is understood that the order of specific construction steps can be re-ordered or combined. For example, the steps 104 and forward are described above as being performed after all the materials are transported from Earth to LEO. In other embodiments, the transportation step 102 is divided into multiple transportation steps, and after each payload is delivered to the propellant depot in LEO, subsequent fueling and/or loading steps are performed related to the delivered supplies. In one example, a first transportation step 102 transports the propellant depot from Earth to LEO. In a separate second transportation step, the tug is transported from Earth to the propellant depot. In a third separate transportation step, a first portion of the base structure components are transported to the propellant depot, and concurrently with the third transportation step, the tug is fueled from the propellant depot. Upon arrival of the third transportation launch vehicle, the tug is loaded with one or more base structure components. The tug then transports the loaded base structure components to GEO. While the tug is being loaded and/or while the tug is traveling to GEO, a fourth transportation step is performed to transport a portion or all of the propellant stages to the propellant depot in LEO. This is but one example of how the construction steps can be re-ordered or concurrently performed. It is understood that many other options are also available that enables the piecemeal construction and completion of the space platform in GEO using the reusable tug and propellant stages.

Each of the steps performed in the space construction method are automated, performed robotically by independent devices and/or devices integrated into some or all of the devices, vehicles, and components described above. In this manner, the space construction method is a completely automated process, which does not require a manned presence. In other embodiments, personnel can be used to perform one, some, or all of the steps in the space construction method.

FIGS. 2-7 illustrate an exemplary system architecture in various stages of constructing the space platform in GEO. The system 200 of FIGS. 2-7 is complimentary to the construction method of FIG. 1, and as such, the system 200 includes the elements described in the construction method of FIG. 1. The system 200 includes the Earth 10, the LEO 20, the GEO 30, the propellant depot 40, the tug 50, the propulsion stages 60, 62, 64, and a portion of the space platform 70 including the base structure component 72 and the solar arrays 80, 82, 84, 86, 88, 90.

In FIG. 2, the propellant depot 40, the tug 50, and the base structure component 72 are launched into LEO 20. The tug 50 is fueled from the propellant depot 40, the base structure component 72 is loaded onto the tug 50, and the tug 50 transports the base structure component 72 to GEO.

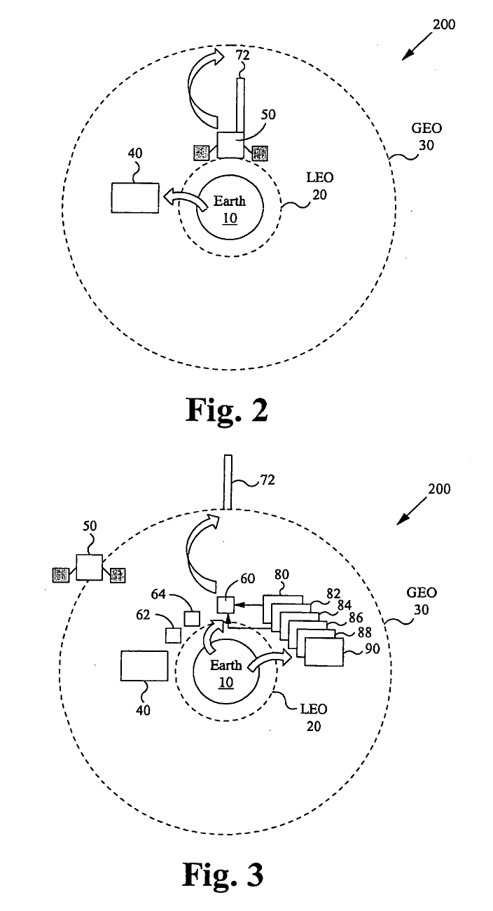

In FIG. 3, the propulsion stages 60, 62, 64 and the solar arrays 80-90 are launched into LEO. The propulsion stages 60, 62, 64 are fueled from the propellant depot 40, the solar arrays 80, 82 are mounted onto the propulsion stage 60, and the propulsion stage 60 transports the solar arrays 80, 82 to the base structure component 72 in GEO.

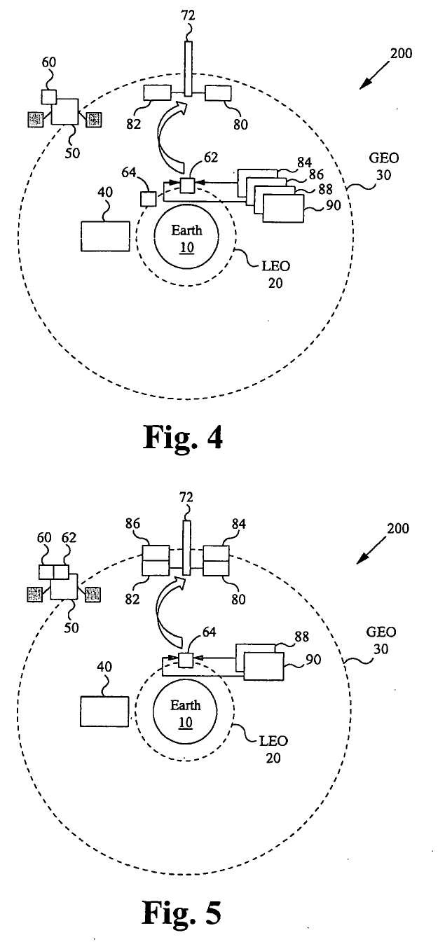

In FIG. 4, the solar arrays 80, 82 are removed from the propulsion stage 60, and the removed solar arrays 80, 82 are mounted to the base structure component 72. The propulsion stage 60 less the solar arrays 80, 82 is coupled as cargo to the tug 50. The solar arrays 84, 86 are mounted onto the propulsion stage 62 and the propulsion stage 62 transports the solar arrays 84, 86 to the base structure component 72 in GEO.

In FIG. 5, the solar arrays 84, 86 are removed from the propulsion stage 62, and the removed solar arrays 84, 86 are mounted to the base structure component 72. The propulsion stage 62 less the solar arrays 84, 86 is coupled as cargo to the tug 50. The solar arrays 88, 90 are mounted onto the propulsion stage 64 and the propulsion stage 64 transports the solar arrays 88, 90 to the base structure component 72 in GEO.

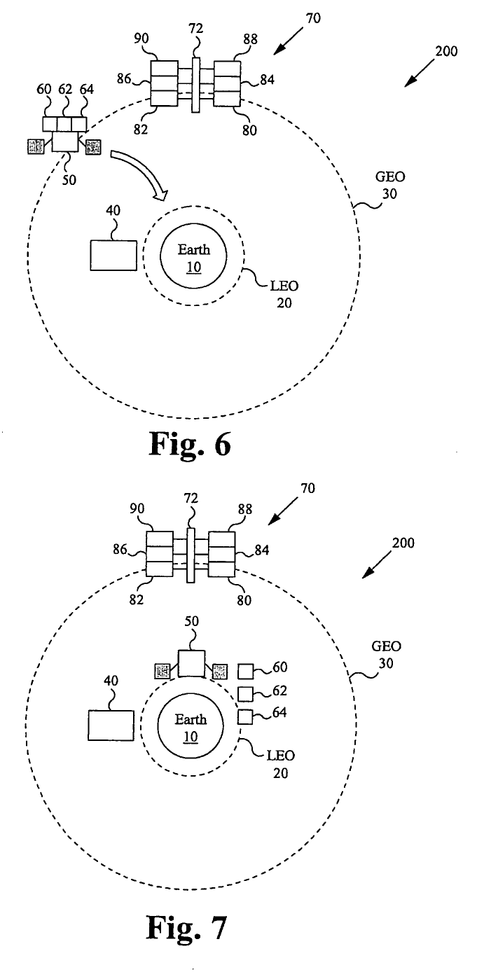

In FIG. 6, the solar arrays 88, 90 are removed from the propulsion stage 64, and the removed solar arrays 88, 90 are mounted to the base structure component 72. The propulsion stage 64 less the solar arrays 88, 90 is coupled as cargo to the tug 50. The tug 50 transports the propulsion stages 60, 62, 64 from GEO to the propellant depot 40 in LEO.

In FIG. 7, the tug 50 and the propulsion stages 60, 62, 64 refuel from the propellant depot 40 and are prepared to repeat the cycle of transporting additional base structure components (not shown) and additional solar arrays (not shown) from LEO to the portion of the space platform 70. This cycle is repeated as many times as necessary to complete the space platform in GEO. As needed, additional supplies, including fuel, base structure components, solar arrays, and other construction materials and equipment are transported from Earth to the propellant depot in LEO.

Similarly to the construction method of FIG. 1, the various system stages described above in FIGS. 2-7 and the order of the steps are for exemplary purposes only. It is understood that the order of specific construction steps and the various stages can be re-ordered or combined.

The space construction method and system transports into LEO construction materials, the propellant depot, SEP vehicles for transporting payload between LEO and GEO, and robotic equipment to transfer materials between various vehicles and to assemble the transported construction materials. The tug SEP vehicle transports heavier construction materials from the propellant depot in LEO to the construction area in GEO. The propulsion stage SEP vehicles transport lighter construction materials from the propellant depot to the construction area. The tug is also configured to transport the fuel-depleted propulsion stages from GEO back to the propellant depot in LEO, where both the tug and the propellant stages are refueled and reloaded for another trip to the construction area in GEO. As additional supplies are needed, such as fuel to refill the propellant depot, base structure components, and solar arrays, these supplies are transported from Earth to the propellant depot in LEO. In this manner, the propellant depot, the tug, and the propellant stages are reusable, thereby enabling many transportation cycles between the staging area in LEO and the construction area in GEO.

The system and method described above are described in terms of an Earth-LEO-GEO system. It is alternatively contemplated that the system and method can be used to construct a space platform in any orbit including, but not limited to, a Geosynchronous Earth Orbit (GEO). The system and method described above are also described in terms of a two orbit system, the LEO and the GEO, where a single staging area in the LEO and a single construction area in the GEO are used. It is alternatively contemplated that the system and method are extended in function to utilize more than two orbits, for example the LEO, the GEO, and a third orbit, a Medium Earth Orbit (MEO) situated between the LEO and the GEO. In this example, the MEO can be used as either an additional staging area for refueling and temporarily storing supplies, such as the LEO in the above described system and method, or as an additional construction area, where larger portions of the completed space platform are completed prior to transport to GEO. It is further contemplated that at any of the orbits, multiple different staging areas can be established. In this case, each different staging area can independently receive launch vehicles from Earth to receive supplies. Tugs can be used to transport supplies between the different staging areas within the same orbit. In general, the system and method utilize reusable, SEP vehicles to transfer supplies from one or more lower-Earth orbit stagging areas to one or more higher-Earth orbit stagging areas and/or construction areas.

The system and method described above are described in terms of a single tug system. In other embodiments, multiple tugs can be used, either independently or in unison. Each tug can be used to perform any of the steps described above related to the single tug embodiment. In this manner, the division of labor for tug related steps can be divided, and/or the overall tug related performance capacity of the system can be increased.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A system for constructing a structure in space, the system comprising:
a. a propellant depot positioned in a lower-Earth orbit;
b. one or more propulsion stages each configured to transport cargo from the lower-Earth orbit to a higher-Earth orbit;
c. a tug configured to transport hardware between the propellant depot in lower-Earth orbit and the higher-Earth orbit, and to transport one or more propulsion stages less cargo from the higher-Earth orbit to the propellant depot in lower-Earth orbit; and
b. a launch vehicle configured to transport the propellant depot, the tug, the hardware, the one or more propulsion stages, and the cargo from Earth to the lower-Earth orbit.

2. The system of claim 1 wherein each propulsion stage is configured to receive fuel from the propellant depot.

3. The system of claim 1 wherein each propulsion stage comprises one or more of a Hall thruster, an ion thruster, a pulsed induction thruster, a Farad and a VASIMR.

4. The system of claim 1 wherein the cargo comprises a plurality of solar arrays.

5. The system of claim 4 wherein the one or more solar arrays are configured to be mounted to the propulsion stage while in the lower-Earth orbit and to be removed from the propulsion stage once in higher-Earth orbit, and each propulsion stage includes solar electric propulsion and is configured to receive solar-based energy from the mounted one or more solar arrays.

6. The system of claim 1 wherein the tug is configured to receive fuel from the propellant depot.

7. The system of claim 1 wherein the hardware comprises a plurality of base structure components.

8. The system of claim 1 wherein the tug includes solar electric propulsion.

9. The system of claim 1 wherein the structure comprises the cargo coupled to the hardware in higher-Earth orbit.

10. A method of constructing a structure in space, the method comprising:
a. transporting a propellant depot, a tug, hardware, cargo, and one or more propulsion stages from Earth to a lower-Earth orbit;
b. loading the tug with the hardware, transporting the tug including the hardware to a higher-Earth orbit, and removing the hardware from the tug;
c. loading each of the one or more propulsion stages with cargo, transporting the one or more propulsion stages to the higher-Earth orbit, and removing the cargo from each of the one or more propulsion stages; and
d. coupling one or more of the one or more propulsion stages to the tug and transporting each of the propulsion stages from the higher-Earth orbit to the propellant stage in the lower-Earth orbit.

11. The method of claim 10 wherein the higher-Earth orbit is further from Earth than the lower-Earth orbit.

12. The method of claim 10 wherein the one or more propulsion stages are transported to the hardware in the higher-Earth orbit.

13. The method of claim 10 wherein the hardware comprises a plurality of base structure components.

14. The method of claim 10 wherein the cargo comprises a plurality of solar arrays.

15. The method of claim 14 further comprising mounting one or more solar arrays to each of the propulsion stages.

16. The method of claim 15 further comprising removing the one or more solar arrays mounted to each propulsion stage, and mounting the one or more solar arrays removed from each propulsion stage to the hardware in the higher-Earth orbit.

17. The method of claim 15 wherein the tug and each of the one or more propulsion stages includes solar electric propulsion.

18. The method of claim 15 wherein each propulsion stage receives solar-based energy from the one or more solar arrays while the one or more solar arrays are mounted to the propulsion stage.

19. The method of claim 10 wherein the step of transporting the propellant depot, the tug, the hardware, the cargo, and the one or more propulsion stages, loading the tug with the hardware, transporting the tug to the higher-Earth orbit, removing the hardware from the tug, loading each of the one or more propulsion stages with cargo, transporting the one or more propulsion stages to the higher-Earth orbit, removing the cargo from each of the one or more propulsion stages, coupling one or more of the one or more propulsion stages to the tug, and transporting each of the propulsion stages is performed robotically such that the method of constructing is fully automated.

20. The method of claim 10 further comprising:
a. fueling the tug from the propellant depot; and
b. fueling each of the one or more propulsion stages from the propellant depot.

21. The method of claim 10 further comprising:
a. reloading the tug with additional hardware, transporting the tug including the additional hardware to the higher-Earth orbit, and removing the additional hardware from the tug;
b. mounting the additional hardware to the previously transported hardware;
c. loading additional cargo into each of the propulsion stages, and transporting the one or more propulsion stages including the additional cargo to the hardware in the higher-Earth orbit;
d. removing the additional cargo from each propulsion stage, and mounting the additional cargo removed from each propulsion stage to the hardware or the additional hardware; and
e. coupling each of the propulsion stages less the additional cargo to the tug and transporting each of the propulsion stages from the higher-Earth orbit to the propellant stage in lower-Earth orbit.

22. The method of claim 21 further comprising:
a. refueling the tug from the propellant depot; and
b. refueling each of the plurality of propulsion stages from the propellant depot.

23. The method of claim 21 further comprising periodically transporting additional supplies from Earth to lower-Earth orbit, wherein the additional supplies include additional fuel for the propellant depot, additional hardware, and additional cargo.

24. The method of claim 21 further comprising repeating the steps of reloading the tug, transporting the tug, removing the additional hardware, mounting the additional hardware, loading additional cargo, transporting the one or more propulsion stages, removing the additional cargo, mounting the additional cargo, coupling each of the propulsion stages less the additional cargo to the tug, and transporting each of the propulsion stages from the higher-Earth orbit to the propellant stage in lower-Earth orbit until the structure in higher-Earth orbit is completed.

25. The method of claim 10 wherein lower-Earth orbit comprises an altitude of about 300 km to about 500 km.

26. The method of claim 10 wherein the higher-Earth orbit comprises a Geosynchronous Earth Orbit.

27. The method of claim 10 wherein the propellant depot includes one or more fuel storage tanks, fuel stored in the fuel storage tanks, transfer equipment configured to transfer materials from a launch vehicle to the tug and to each of the propulsion stages, and a power system.

28. The method of claim 10 wherein the fuel comprises one of the group consisting of argon, xenon, ammonia, water, hydrogen and other fuels used in electric propulsion systems.

29. The method of claim 10 wherein the tug includes about 300 kW to more than 1000 kW of electric power.

30. The method of claim 10 wherein the tug is configured to transport up to about 10,000 kg.

31. The method of claim 10 wherein each propulsion stage is configured to transport up to about 1500 kg.

32. The method of claim 10 wherein the tug and each propulsion stage comprises one or more fuel tanks, an electric propulsion thruster system, an attitude control system, a power management system, memory, a power processing system, and a guidance, navigation, and control system.

33. The method of claim 10 wherein each propulsion stage includes about 100 kW to about 500 kW of electric power.

34. The method of claim 10 wherein each propulsion stage comprises one or more of a Hall thruster, an ion thruster, a pulsed induction thruster, a Farad and a VASIMR

35. The method of claim 10 further comprising utilizing a plurality of tugs.

36. The method of claim 10 wherein the structure is a space-based solar power platform.

37. A system for constructing a structure in space, the system comprising:
a. a propellant depot configured to store fuel, wherein the propellant depot is positioned in a lower-Earth orbit;
b. one or more propulsion stages each configured to receive fuel from the propellant depot and to transport one or more solar arrays from the lower-Earth orbit to a higher-Earth orbit, wherein the one or more solar arrays are configured to be mounted to the propulsion stage while in the lower-Earth orbit and to be removed from the propulsion stage once in higher-Earth orbit, and each propulsion stage includes solar electric propulsion and is configured to receive solar-based energy from the mounted one or more solar arrays;
c. a tug configured to receive fuel from the propellant depot, to transport one or more base structure components between the propellant depot in lower-Earth orbit and the higher-Earth orbit, and to transport one or more of the one or more propulsion stages less solar arrays from the higher-Earth orbit to the propellant depot in lower-Earth orbit, wherein the tug includes solar electric propulsion; and
b. a launch vehicle configured to transport the propellant depot, the tug, the base structure components, the one or more propulsion stages, and the solar arrays from Earth to the lower-Earth orbit;
wherein the structure comprises each base structure component coupled to at least one other base structure component in higher-Earth orbit, and each solar array coupled to at least one base structure component in higher-Earth orbit.

38. The system of claim 37 further comprising one or more robotic devices configured to load and unload the one or more base structure components on and off the tug, to mount and remove the one or more solar arrays on and off each propulsion stage, and to construct the structure in higher-Earth orbit using the base structure components and the solar arrays.

39. The system of claim 37 wherein the propellant depot, the one or more propulsion stages, and the tug are automated.

40. The system of claim 37 further comprising a plurality of tugs.

41. The system of claim 37 further comprising a plurality of launch vehicles.

42. The system of claim 37 wherein the propellant depot, the one or more propulsion stages, the tug, and the launch vehicle are reusable.

43. The system of claim 37 wherein the launch vehicle is configured to transport additional supplies from Earth to lower-Earth orbit, wherein the additional supplies include additional fuel for the propellant depot, additional base structure components, and additional solar arrays.

44. The system of claim 37 wherein the tug and the one or more propulsion stages are configured to be refueled.

45. The system of claim 37 wherein lower-Earth orbit comprises an altitude of about 300 km to about 500 km.

46. The system of claim 37 wherein the higher-Earth orbit comprises a Geosynchronous Earth Orbit.

47. The system of claim 37 wherein the propellant depot includes one or more fuel storage tanks, fuel stored in the propellant storage tanks, transfer equipment configured to transfer materials from a launch vehicle to the tug and to each of the propulsion stages, and a power system.

48. The system of claim 37 wherein the fuel comprises one of the group consisting of argon, xenon, ammonia, water, hydrogen and other fuels used in electric propulsion systems.

49. The system of claim 37 wherein the tug includes about 300 kW to more than 1000 kW of electric power.

50. The system of claim 37 wherein the tug is configured to transport up to about 10,000 kg.

51. The system of claim 37 wherein each propulsion stage is configured to transport up to about 1500 kg.

52. The system of claim 37 wherein the tug and each propulsion stage comprises one or more fuel tanks, an electric propulsion thruster system, an attitude control system, a power management system, memory, a power processing system, and a guidance, navigation, and control system.

53. The system of claim 37 wherein each propulsion stage includes about 100 kW to about 500 kW of electric power.

54. The system of claim 37 wherein each propulsion stage comprises one or more of a Hall thruster, an ion thruster, a pulsed induction thruster, a Farad and a VASIMR

55. The system of claim 37 further comprising a plurality of tugs.

56. The system of claim 37 wherein the structure is a space-based solar power platform.

57. The system of claim 37 wherein each propulsion stage is configured to receive solar-based energy from the one or more solar arrays while the one or more solar arrays are mounted to the propulsion stage.

58. A method of constructing a structure in space, the method comprising:
a. transporting a propellant depot, a tug, a plurality of base structure components, and one or more propulsion stages, and a plurality of solar arrays from Earth to a lower-Earth orbit, wherein the tug and each of the plurality of propellant stages includes solar electric propulsion;
b. fueling the tug from the propellant depot, loading the tug with one or more base structure components, and transporting the tug including the one or more base structure components to a higher-Earth orbit which is further from Earth than the lower-Earth orbit, and removing the one or more base structure components from the tug;
c. fueling each of the one or more propulsion stages from the propellant depot, mounting one or more solar arrays to each of the propellant stages, and transporting the one or more propulsion stages including the mounted solar arrays to the one or more base structure components in the higher-Earth orbit;
d. removing the one or more solar arrays mounted to each propulsion stage, and mounting the one or more solar arrays removed from each propulsion stage to the one or more base structure components in the higher-Earth orbit; and
e. coupling one or more of the one or more propulsion stages less the solar arrays to the tug and transporting each of the propulsion stages from the higher-Earth orbit to the propellant stage in lower-Earth orbit.
